(19) United States
(12) Patent Application Publication
(10) Pub. No.: US 2019/0081855 A1
(43) Pub. Date: Mar. 14, 2019

(54) DISCREPANCY DETECTION BY CONFIGURATION SERVERS

(71) Applicant: Futurewei Technologies, Inc., Plano, TX (US)

(72) Inventors: Alexander Clemm, Los Gatos, CA (US); Yingzhen Qu, San Jose, CA (US); Evgeny Tantsura, Palo Alto, CA (US)

(21) Appl. No.: 15/853,147

(22) Filed: Dec. 22, 2017

Related U.S. Application Data
(60) Provisional application No. 62/558,759, filed on Sep. 14, 2017.

(51) Int. Cl. H04L 12/24; G06F 17/30

(52) U.S. Cl. CPC H04L 41/0803; G06F 17/30864

(57) ABSTRACT

A computer-implemented method of discrepancy detection by a configuration server is provided that comprises: receiving, by one or more processors of the configuration server, a request to compare a first management datastore with a second management datastore; comparing, by the one or more processors of the configuration server, the first management datastore with the second management datastore to identify differences; and in response to the request, sending over a network, by the one or more processors of the configuration server, the differences.

### PRIORITY CLAIM

This application claims the benefit of priority to U.S. Provisional Patent Application Ser. No. 62/558,759, filed Sep. 14, 2017, and entitled “DISCREPANCY DETECTION IN NMDA-ENABLED MANAGEMENT FRAMEWORKS,” which provisional application is incorporated herein by reference in its entirety.

### TECHNICAL FIELD

The present disclosure is related to configuration servers and, in one particular embodiment, to discrepancy detection by configuration servers.

### BACKGROUND

YANG (an initialism for “yet another next generation”) is a data modeling language used to model configuration and state data manipulated by the Network Configuration Protocol (NETCONF). NETCONF provides the ability to install, manipulate, and delete the configuration of network resources (e.g., configuration data stored in a configuration file). NETCONF uses three management datastores: candidate, running, and startup. A management datastore is an operational abstraction of a resource, containing a set of hierarchical management data. A resource is any hardware or software device that can be configured using a configuration server.

Unlike the data in a database, the data contained in a management datastore does not necessarily reside in a file system, but can include states of hardware registers or other memory components. The startup datastore contains data defining the configuration for a network resource to be applied at startup of that resource. The candidate datastore contains the requested configuration of the resource. The running datastore contains the current configuration of the resource. RESTCONF is a management protocol based on hypertext transport protocol (HTTP) that represents a lightweight alternative to NETCONF.

The Network Management Datastore Architecture (NMDA) defines a management datastore as a data storage structure applicable to all management data, not only configuration data. An intended datastore contains a validated configuration for a network resource. An operational datastore contains configuration data that is actually in effect for the network resource. The operational datastore may also contain non-configuration data. Other management datastores are also supported by NMDA, such as a dynamic datastore. An NMDA-enabled management framework provides functions that comply with the NMDA proposed standard. A configuration server provides functions to access and manipulate multiple management datastores. An NMDA server that implements an NMDA-enabled management framework is a configuration server.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

According to one aspect of the present disclosure, a computer-implemented method of discrepancy detection by a configuration server is provided that comprises: receiving, by one or more processors of the configuration server, a request to compare a first management datastore with a second management datastore; comparing, by the one or more processors of the configuration server, the first management datastore with the second management datastore to identify differences; and in response to the request, sending over a network, by the one or more processors of the configuration server, the differences.

Optionally, in any of the preceding aspects, the receiving of the request comprises receiving an NMDA command.

Optionally, in any of the preceding aspects, the NMDA command is a NETCONF command.

Optionally, in any of the preceding aspects, the NMDA command is a RESTCONF command.

Optionally, in any of the preceding aspects, the receiving of the NMDA command comprises receiving an identifier of the first management datastore, an identifier of the second management datastore, and a filter.

Optionally, in any of the preceding aspects, the receiving of the NMDA command further comprises receiving a dampening period.

Optionally, in any of the preceding aspects, the comparing of the first management datastore with the second management datastore comprises: selecting data from the first management datastore using the filter; and selecting data from the second management datastore using the filter.

Optionally, in any of the preceding aspects, the comparing of the first management datastore with the second management datastore comprises: selecting data from the first management datastore using a first filter; and selecting data from the second management datastore using a second filter that is different from the first filter.

Optionally, in any of the preceding aspects, the second filter is based on the first filter and an origin.

According to one aspect of the present disclosure, a configuration server is provided that comprises: a memory storage comprising instructions; and one or more processors in communication with the memory storage, wherein the one or more processors execute the instructions to perform: receiving a request to compare a first management datastore with a second management datastore; comparing the first management datastore with the second management datastore to identify differences; and in response to the request, sending the differences over a network.

Optionally, in any of the preceding aspects, the receiving of the request comprises receiving an NMDA command.

Optionally, in any of the preceding aspects, the NMDA command is a NETCONF command.

Optionally, in any of the preceding aspects, the NMDA command is a RESTCONF command.

Optionally, in any of the preceding aspects, the receiving of the NMDA command comprises receiving an identifier of the first management datastore, an identifier of the second management datastore, and a filter.

Optionally, in any of the preceding aspects, the receiving of the NMDA command further comprises receiving a dampening period.

Optionally, in any of the preceding aspects, the comparing of the first management datastore with the second management datastore comprises: selecting data from the first management datastore using the filter; and selecting data from the second management datastore using the filter.

Optionally, in any of the preceding aspects, the comparing of the first management datastore with the second management datastore comprises: selecting data from the first management datastore using a first filter; and selecting data from the second management datastore using a second filter that is different from the first filter.

Optionally, in any of the preceding aspects, the second filter is based on the first filter and an origin.

According to one aspect of the present disclosure, a non-transitory computer-readable medium storing computer instructions for detecting discrepancies by a configuration server is provided, that when executed by one or more processors of the configuration server, causes the one or more processors to perform steps of: receiving a request to compare a first management datastore with a second management datastore; comparing the first management datastore with the second management datastore to identify differences; and in response to the request, sending the differences over a network.

Optionally, in any of the preceding aspects, the receiving of the request comprises receiving an NMDA command.

Any one of the foregoing examples may be combined with any one or more of the other foregoing examples to create a new embodiment within the scope of the present disclosure.

### BRIEF DESCRIPTION OF THE DRAWINGS

FIG. 1 is an illustration of an example network organization for discrepancy detection by a configuration server, according to some example embodiments.

FIG. 2 is a block diagram illustrating circuitry for clients and servers that implement algorithms and perform methods, according to some example embodiments.

FIG. 3 is a flowchart illustration of a method of discrepancy detection by a configuration server, according to some example embodiments.

FIG. 4 is a flowchart illustration of a method of discrepancy detection by a configuration server, according to some example embodiments.

FIG. 5 is a flowchart illustration of a method of discrepancy detection by a configuration server, according to some example embodiments.

FIG. 6 is a flowchart illustration of a method of discrepancy detection by a configuration server, according to some example embodiments.

FIG. 7 is a flowchart illustration of a method of time-validating differences by a configuration server, according to some example embodiments.

FIG. 8 is a flowchart illustration of a method of generating an alert by a client, according to some example embodiments.

### DETAILED DESCRIPTION

In the following description, reference is made to the accompanying drawings that form a part hereof, and in which are shown, by way of illustration, specific embodiments which may be practiced. These embodiments are described in sufficient detail to enable those skilled in the art to practice the inventive subject matter, and it is to be understood that other embodiments may be utilized and that structural, logical, and electrical changes may be made without departing from the scope of the present disclosure. The following description of example embodiments is, therefore, not to be taken in a limiting sense, and the scope of the present disclosure is defined by the appended claims.

The functions or algorithms described herein may be implemented in software, in one embodiment. The software may consist of computer-executable instructions stored on computer-readable media or a computer-readable storage device such as one or more non-transitory memories or other types of hardware-based storage devices, either local or networked. The software may be executed on a digital signal processor, application-specific integrated circuit (ASIC), programmable data plane chip, field-programmable gate array (FPGA), microprocessor, or other type of processor operating on a computer system, such as a switch, server, or other computer system, turning such a computer system into a specifically programmed machine.

Configuration of resources may include setting an intended configuration parameter in an intended datastore and then checking to see if the intended configuration has taken place, as represented by data in an operational datastore. Thus, an existing NETCONF client may request data from both the intended datastore and the operational datastore and perform a comparison. The NETCONF server will have to transmit data from both the operational datastore and the intended datastore whether or not there is a difference between the data in the two datastores, consuming network resources. The NETCONF client will have to perform the comparison of the data, consuming client resources.

In some example embodiments, NETCONF is extended by adding a new management operation, compare, that compares two management datastores to determine if they contain the same values. The compare operation may take three parameters: an identifier of a source datastore, an identifier of a target datastore, and a filter that specifies which portions of the management datastores to compare. The compare operation may provide an output that specifies the discrepancies between the source datastore and the target datastore. The output may identify a set of data nodes present in both datastores, wherein the two datastores have different values for each data node in the set. The different values may be included in the output. Additionally or alternatively, the output may identify a set of data nodes present in the source datastore but not present in the target datastore, a set of data nodes present in the target datastore but not present in the source datastore, or any suitable combination thereof.

In some example embodiments, the compare operation may accept a dampening period as a fourth parameter. In these example embodiments, the set of data nodes reported as differences between the two management datastores is limited to those that have remained different for the dampening period. Thus, short-lived differences between the management datastore will be ignored. As used herein, the term “NMDA command” encompasses both NETCONF and RESTCONF commands, as well as commands of any future protocols that support NMDA.

Using existing NETCONF commands, to determine if configuration changes have successfully propagated to an operational datastore, a NETCONF client must request a copy of the desired portions of the operational datastore for comparison with the requested configuration (either stored locally on the NETCONF client or requested from a NETCONF server). In addition to the processor use on the NETCONF client to perform the comparison and the processor use on the NETCONF server to retrieve the data, network bandwidth is consumed in transmitting the data from the NETCONF server to the NETCONF client.

Using the methods and systems described herein, the comparison of management datastores may be performed on the NETCONF server, reducing the network bandwidth consumption. Additionally, in some example embodiments, differences are not reported when the differences are likely caused by propagation delay instead of error. This reduces unnecessary processing and reporting of delay-induced discrepancies. Accordingly, the methods and systems described herein may facilitate troubleshooting of problems caused by inconsistencies between NMDA management datastores and aid in mitigating and avoiding such problems.

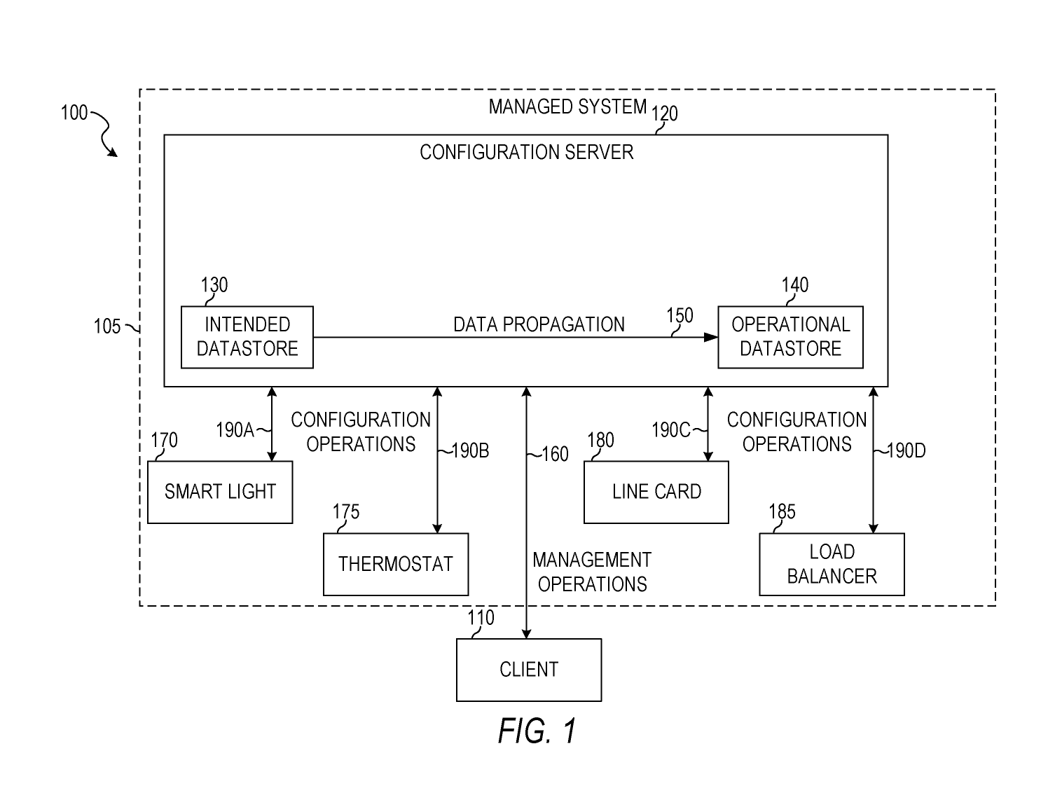

FIG. 1 is an illustration of an example network organization 100 for discrepancy detection by a configuration server, according to some example embodiments. The example network organization 100 includes a client 110 (e.g., a NETCONF client or a RESTCONF client) interacting with a managed system 105 that includes a configuration server 120 (e.g., a NETCONF server or a RESTCONF server) and four managed resources: a smart light 170, a thermostat 175, a line card 180, and a load balancer 185. The configuration server 120 interacts with the managed resources via configuration operations 190A, 190B, 190C, and 190D. The configuration server 120 interacts with the client 110 via management operations 160 (e.g., via a network). The client 110 may be a computer used by a user in a smart home, a system used by a network administrator, or another NETCONF client. The configuration server 120 includes an intended datastore 130 and an operational datastore 140, each of which is a management datastore. Data is communicated from the intended datastore 130 to the operational datastore 140 via the data propagation 150. The configuration server 120 is described as being a NETCONF server or a RESTCONF server, but the systems and methods disclosed herein apply to other types of configuration servers as well.

The operational datastore 140 stores configuration data that reflects the current operational state of one or more resources (e.g., the smart light 170, the thermostat 175, the line card 180, and the load balancer 185). The intended datastore 130 stores configuration data that reflects the intended state of one or more resources. When all intended configuration changes have been applied, the operational datastore 140 and the intended datastore 130 will contain matching data. The method of communicating the intended state from the configuration server 120 to the resource and the operational state from the resource to the configuration server 120 may be implementation-specific. For example, the configuration server 120 may communicate with the managed resources via an application programming interface (API) provided by each managed resource. The client 110 may be implemented in a client program running on a desktop computer, a mobile device connected to the desktop computer via the wireless network, or a remote computer connected to the configuration server 120 via the Internet.

Differences between the operational datastore 140 and the intended datastore 130 may be caused by propagation delay. For example, configuration change requests may be written to the intended datastore 130 when received by the configuration server 120 and then implemented in the operational datastore 140 via the data propagation 150. Since the data propagation 150 is not instantaneous, the operational datastore 140 is different from the intended datastore 130 immediately after a change request is received by the configuration server 120. The data propagation 150 may include transmitting a configuration change to a resource via a configuration operation, waiting for the resource to implement the configuration change, and receiving updated state data from the resource. For example, a command to turn off the smart light 170 may be immediately reflected by changing data for the status of the light to off in the intended datastore 130, but the data in the operational datastore 140 will not be changed from on to off until the smart light 170 reports that it is off.

Differences between the operational datastore 140 and the intended datastore 130 may be caused by a delay in compliance by the resource. For example, a command may be issued to the thermostat 175 to raise the temperate of a room by five degrees, from 67 degrees to 72 degrees Fahrenheit. Since it takes time to raise the temperature, referred to as a dampening period, the intended state (72 degrees) and the operational state (e.g., 68 degrees) will not match until the thermostat 175 has completed raising the temperature of the room. Accordingly, a difference between the intended temperature and the operational temperature does not indicate a problem unless the difference persists for longer than the expected time to change the temperature. In this example, the dampening period might be 30 minutes. By contrast, the delay in compliance for the smart light 170 might be much smaller and the dampening period could be 500 ms. Thus, the dampening period may be predetermined and based on the resource. For example, a database may store a predetermined dampening period for each resource managed by the configuration server 120, may store a predetermined dampening period for each type of resource managed by the configuration server 120, or any suitable combination thereof.

The smart light 170 and thermostat 175 are examples of managed resources in a home automation application, but perhaps a more common use of the configuration manager 120 is in a data center. The line card 180 may be configured to implement bidirectional forwarding detection over open shortest path first (OSPF). The client 110 may set the hello timer, a timer that is used to determine how often the line card 180 checks to see that neighboring devices on the network are still responsive, to 5 seconds via a management command sent to the configuration server 120. The configuration server 120 updates the intended datastore 130 with the set value. The configuration server 120 configures the line card 180 via the configuration operation 190C. If, for some reason, the actual hello time being used by the line card 180, as reflected by the operation datastore 140, is 10 seconds, the client 110 will be informed when a compare request is executed by the configuration server 120. For example, the line card 180 may be suffering a fault that prevents the hello time from being updated, the line card 180 may be running in a special control mode that prevents change of the hello time, a communication error between the configuration server 120 and the line card 180 may prevent the instruction from being propagated to the line card 180, or some other condition may prevent the client's instruction from taking effect.

As another example of a configurable hardware resource, the load balancer 185 may be configured by the client 110 to use a particular weight for a particular server. For example, after a server is upgraded to have additional memory, the weight for that server may be increased so that the load balancer 185 directs more of a distributed workload to the upgraded server. The requested weight is stored in the intended datastore 130 upon receipt of the configuration command by the configuration server 120. Once the weight has been updated by the load balancer 185 (e.g., in response to the configuration operation 190D), the operational datastore 140 is updated. As in the previous example, if the configured resource is unable to implement the requested change, the operational datastore 140 is not updated, and the discrepancy will be reported by a compare request executed by the configuration server 120.

Using systems and methods described herein, the client 110 may request a set of differences between the intended datastore 130 and the operational datastore 140. In response to the request, the configuration server 120 may generate the set of differences and provide the set of differences to the client 110.

Each management datastore is an abstraction provided by the configuration server 120. The instrumentation of the provided abstraction may refer to components residing within the configuration server 120 (e.g., a database, a file, or any suitable combination thereof), or to components residing outside of the configuration server 120 (e.g., in one or more hardware registers of a resource being managed). In some example embodiments, instrumentation code executing on one or more processors of the configuration server 120 accesses hardware registers of devices to update a local copy of the external data prior to receiving a request from the client 110 that utilizes the data. In other example embodiments, instrumentation code executing on one or more processors of the configuration server 120 accesses hardware registers of devices to update a local copy of the external data in response to receiving a request from the client 110 that utilizes the data.

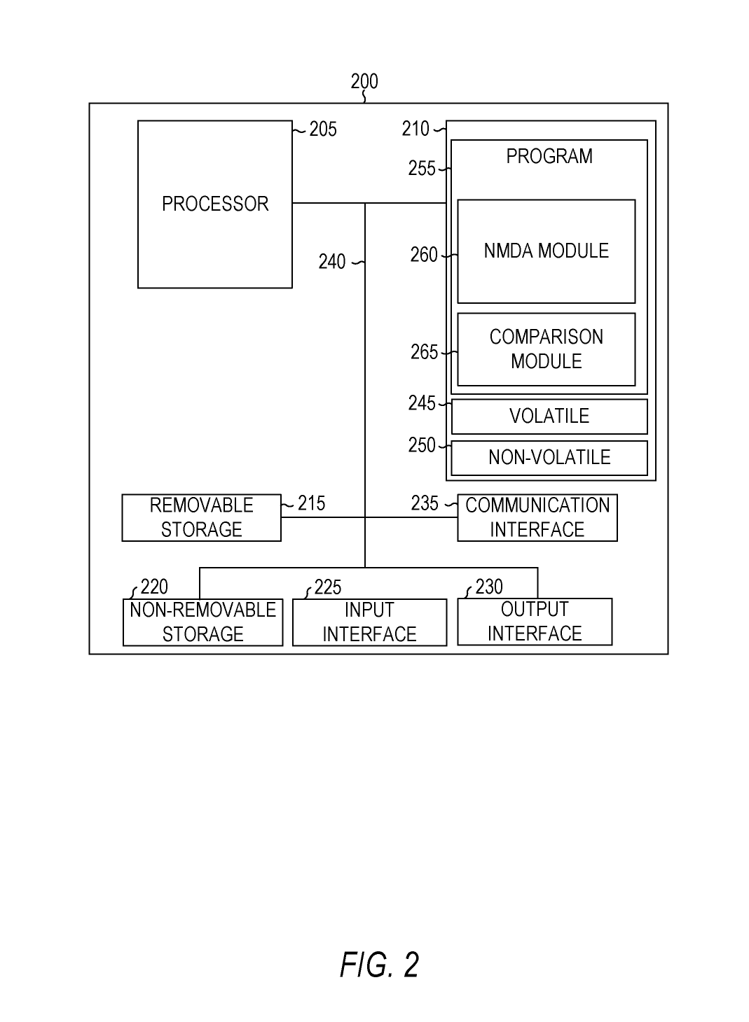

FIG. 2 is a block diagram illustrating circuitry for clients and servers that implement algorithms and perform methods, according to example embodiments. All components need not be used in various embodiments. For example, clients, servers, autonomous systems, and cloud-based network resources may each use a different set of components, or, in the case of servers for example, larger storage devices.

One example computing device in the form of a computer 200 (also referred to as a computing device 200 and a computer system 200) may include a processor 205, memory storage 210, removable storage 215, and non-removable storage 220, all connected by a bus 240. Although the example computing device is illustrated and described as the computer 200, the computing device may be in different forms in different embodiments. For example, the computing device may instead be a smartphone, a tablet, a smartwatch, or another computing device including elements the same as or similar to those illustrated and described with regard to FIG. 2. Devices such as smartphones, tablets, and smartwatches are generally collectively referred to as “mobile devices” or “user equipment.” Further, although the various data storage elements are illustrated as part of the computer 200, the storage may also or alternatively include cloud-based storage accessible via a network, such as the Internet, or server-based storage.

The memory storage 210 may include volatile memory 245 and non-volatile memory 250, and may store a program 255. The computer 200 may include, or have access to a computing environment that includes, a variety of computer-readable media, such as the volatile memory 245, the non-volatile memory 250, the removable storage 215, and the non-removable storage 220. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

The computer 200 may include or have access to a computing environment that includes an input interface 225, an output interface 230, and a communication interface 235. The output interface 230 may interface to or include a display device, such as a touchscreen, that also may serve as an input device. The input interface 225 may interface to or include one or more of a touchscreen, a touchpad, a mouse, a keyboard, a camera, one or more device-specific buttons, one or more sensors integrated within or coupled via wired or wireless data connections to the computer 200, and other input devices. The computer 200 may operate in a networked environment using the communication interface 235 to connect to one or more remote computers, such as database servers. The remote computer may include a personal computer (PC), server, router, network PC, peer device or other common network node, or the like. The communication interface 235 may connect to a local-area network (LAN), a wide-area network (WAN), a cellular network, a WiFi network, a Bluetooth network, or other networks.

Computer instructions stored on a computer-readable medium (e.g., the program 255 stored in the memory storage 210) are executable by the processor 205 of the computer 200. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed in and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example.

The program 255 is shown as including an NMDA module 260 and a comparison module 265. Any one or more of the modules described herein may be implemented using hardware (e.g., a processor of a machine, an ASIC, an FPGA, or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The NMDA module 260 of the configuration server 120 receives and executes NMDA commands (e.g., NETCONF commands or RESTCONF commands). The NMDA module 260 of the client 110 transmits NMDA commands over a network to the configuration server 120 and receives responses to the transmitted NMDA commands.

The comparison module 265 of the configuration server 120 retrieves data from the intended datastore 130 and the operational datastore 140 for comparison. The comparison module 265 compares the retrieved data to identify differences, which are provided to the NMDA module 260 for provision to the client 110.

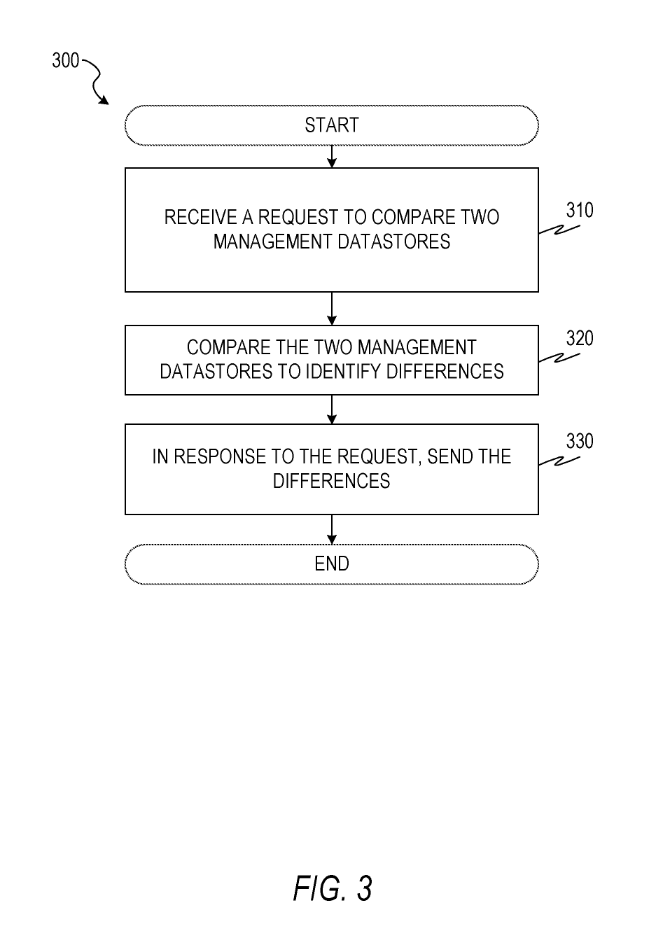

FIG. 3 is a flowchart illustration of a method 300 of discrepancy detection by a configuration server, according to some example embodiments. The method 300 includes operations 310, 320, and 330. By way of example and not limitation, the method 300 is described as being performed by elements of the configuration server 120, described above with respect to FIG. 1, and the computer 200, described above with respect to FIG. 2.

In operation 310, the NMDA module 260 of the configuration server 120 receives a request to compare two management datastores. For example, a compare request, in the form of an NMDA command, that identifies the first management datastore, the second management datastore, and a filter may be received. The request may be provided in an extended markup language (XML) format, a javascript object notation (JSON) format, or any suitable combination thereof. The filter may identify one or more subtrees of the two management datastores to be compared. For example, the XML fragment below may be used to select a top-level node of http://example.com/schema/1.2/config, in the xmlns namespace, and its children for comparison. Other types of filters may also be used, such as attribute match, containment nodes, selection nodes, content match nodes, or any suitable combination thereof.

<filter type=“subtree”>

<top xmlns=“http://example.com/schema/1.2/config”/>

</filter>

In operation 320, the comparison module 265 of the configuration server 120 compares the two management datastores to identify differences. For example, the received filter, if any, may be applied to each of the two management datastores to retrieve filtered data. Alternatively, if no filter is received, a default filter or no filter may be applied. The retrieved data from the two management datastores is compared to identify differences between the two management datastores. For example, data nodes may be present in both management datastores but have different values in one management datastore than in the other. As another example, data nodes may be present in one management datastore and not in the other.

In operation 330, the NMDA module 260 of the configuration server 120 sends the differences in response to the request received in operation 310. For example, any one or more of the following may be sent: a list of data nodes having different values in the two management datastores with the differing values, a list of data nodes having different values in the two management datastores without the differing values, a list of data nodes in the first datastore that are not in the second datastore, a list of data nodes in the second datastore that are not in the first datastore, a tree of data nodes in the first datastore that do not match the corresponding nodes in the second datastore, a tree of data nodes in the second datastore that do not match the corresponding nodes in the first datastore, or any suitable combination thereof. Additionally or alternatively, a tree of data nodes matching the filter may be sent along with an indicator for each data node in the tree, the indicator indicating if a difference was detected for the data node.

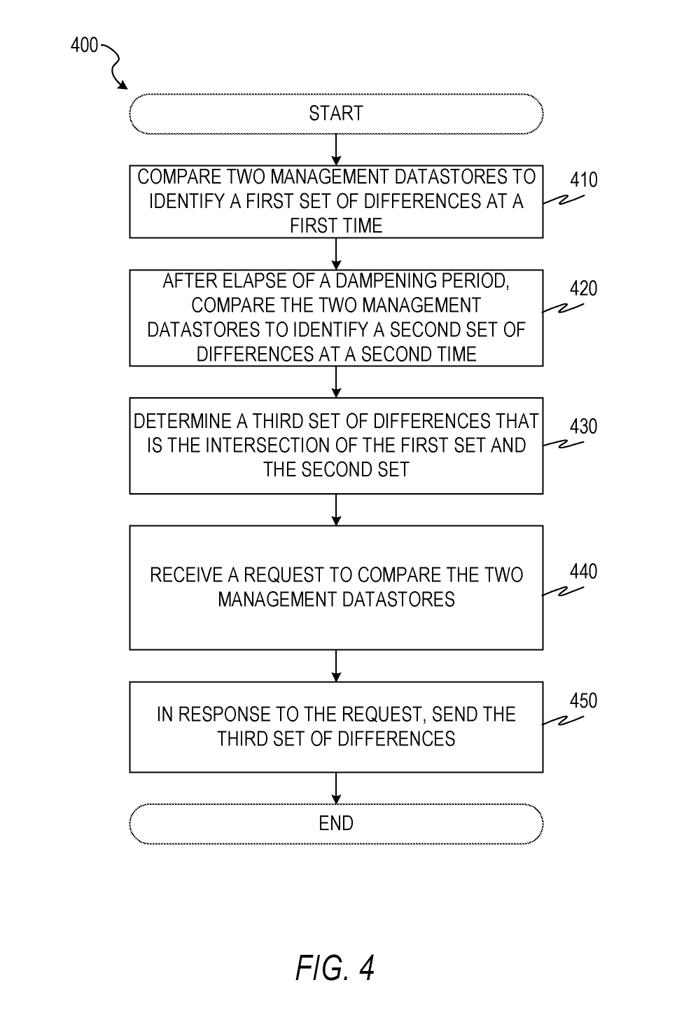

FIG. 4 is a flowchart illustration of a method 400 of discrepancy detection by a configuration server, according to some example embodiments. The method 400 includes operations 410, 420, 430, 440, and 450. By way of example and not limitation, the method 400 is described as being performed by elements of the configuration server 120, described above with respect to FIG. 1, and the computer 200, described above with respect to FIG. 2.

In operation 410, the comparison module 265 of the configuration server 120 compares two management datastores to identify a first set of differences at a first time. For example, the comparison may be performed periodically (e.g., every minute, every five minutes, or every hour), performed in response to a request (e.g., as in operation 320, which is performed in response to the request received in operation 310), or any suitable combination thereof.

In operation 420, after dampening period (e.g., a predetermined period of time), the comparison module 265 of the configuration server 120 compares the two management datastores to identify a second set of differences at a second time. For example, the two management datastores may be compared for a second time as part of the periodic comparison after the dampening period, or compared after the dampening period from the first comparison performed in response to an NMDA command.

In operation 430, the NMDA module 260 of the configuration server 120 determines a third set of differences that is the intersection of the first set and the second set. Thus, only differences that are present both at the first time and at the second time will be included in the third set of differences.

In operation 440, the NMDA module 260 of the configuration server 120 receives a request to compare the two management datastores. In a first example embodiment, the comparison in operation 410 is performed in response to the received request. In a second example embodiment, the comparison in operation 430 is performed in response to the received request. In a third example embodiment, the comparisons in operations 410-430 are performed regardless of whether a request is received. Thus, in the first example embodiment, the dampening period (operation 420) occurs after the request is received (operation 440). In the second example embodiment, periodic comparison of two management datastores (operation 420) occurs regardless of whether a request is received, but determining the intersection of the last two sets of differences (operation 430) occurs after the request is received (operation 440). In the third example embodiment, determining the intersection of the last two sets of differences (operation 430) occurs periodically regardless of whether a request is received. Each of these three embodiments involves a trade-off between latency and calculation overhead.

In operation 450, in response to the request, the NMDA module 260 of the configuration server 120 sends the third set of differences. By comparison with the method 300, the method 400 avoids reporting differences that persist for less than the dampening period. This may avoid reporting differences that are caused by normal propagation delay between the two management datastores, saving resources that would otherwise be expended by the client 110 in attempting to resolve the cause of the differences. Differences caused by unusually long propagation delays may be detected quickly when the dampening period is slightly longer than the normal propagation delay.

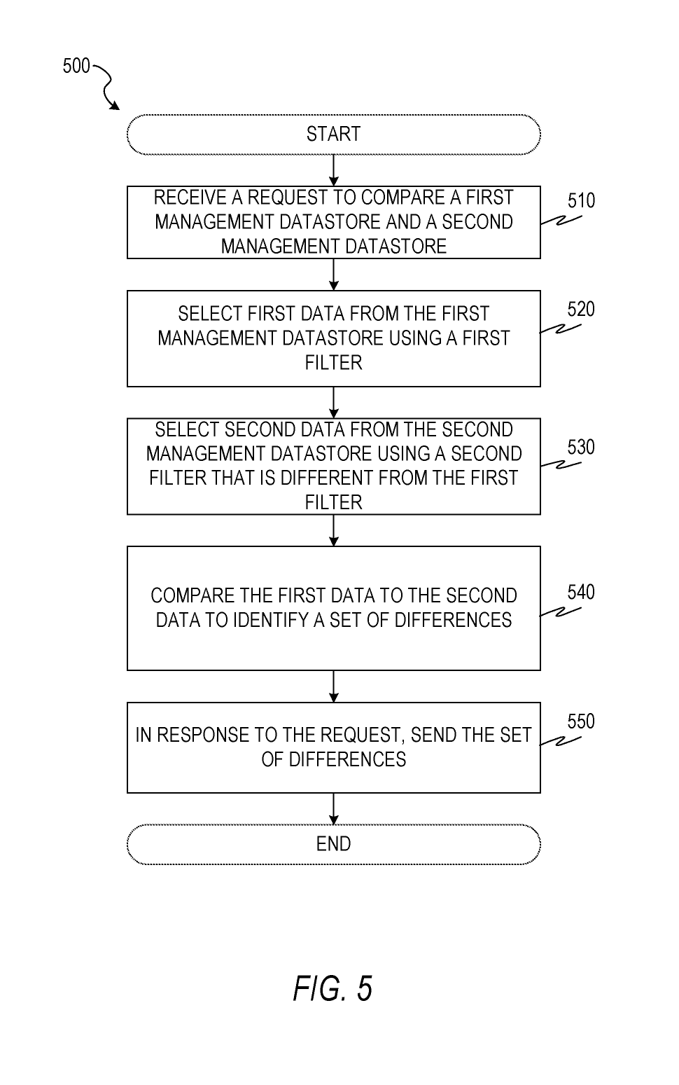

FIG. 5 is a flowchart illustration of a method 500 of discrepancy detection by a configuration server, according to some example embodiments. The method 500 includes operations 510, 520, 530, 540, and 550. By way of example and not limitation, the method 500 is described as being performed by elements of the configuration server 120, described above with respect to FIG. 1, and the computer 200, described above with respect to FIG. 2.

In operation 510, the NMDA module 260 of the configuration server 120 receives a request to compare a first management datastore and a second management datastore. For example, a compare request that identifies the first management datastore, the second management datastore, and a filter may be received.

In operation 520, the NMDA module 260 selects first data from the first management datastore using a first filter. For example, a filter provided in the compare request may be applied, a default filter may be applied, or any suitable combination thereof.

In operation 530, the NMDA module 260 selects data from the second management datastore using a second filter that is different from the first filter. For example, the filter provided in the compare request may be applied with an additional condition (e.g., to only select data nodes in the second management datastore that have an origin of the first management datastore), a different default filter may be applied (e.g., a default filter selected by the NMDA module 260 based on the identifier of the second management datastore), or any suitable combination thereof. An origin is metadata that identifies for a given data item in a datastore, e.g., the <operational> datastore, the source of that data item (e.g., another datastore from which the data item was received such as <intended> or <dynamic>, or another source that generated the data item, such as a “learned” data item or a “system”-generated data item). To illustrate, the first management datastore may be the intended datastore, the second management datastore may be the operational datastore, and the filter provided in the compare request may be represented as a filter F. In this illustration, the filtered results of the intended datastore are those that match the filter F, and the filtered results of the operational datastore are those that match the filter F AND have an origin of the intended datastore. The use of an origin filter is optional and, in other example embodiments, other origin filters are used.

As another illustration, the first management datastore may be the dynamic datastore, the second management datastore may be the operational datastore, and the filter provided in the compare request may be represented as a filter F. In this illustration, the filtered results of the dynamic datastore are those that match the filter F, and the filtered results of the operational datastore are those that match the filter F AND have an origin of the dynamic datastore. The selection of the additional filter applied to the second datastore may be based on the first datastore.

In operation 540, the comparison module 265 compares the first data to the second data to identify a set of differences, and in operation 550, the comparison module 265 sends the set of differences in response to the request. In some example embodiments, the features of the method 400 are combined with the features of the method 500 to provide a method of applying different filters to the two management datastores (as in operations 520 and 530) while avoiding reporting of transient differences (as in operations 410, 420, and 430).

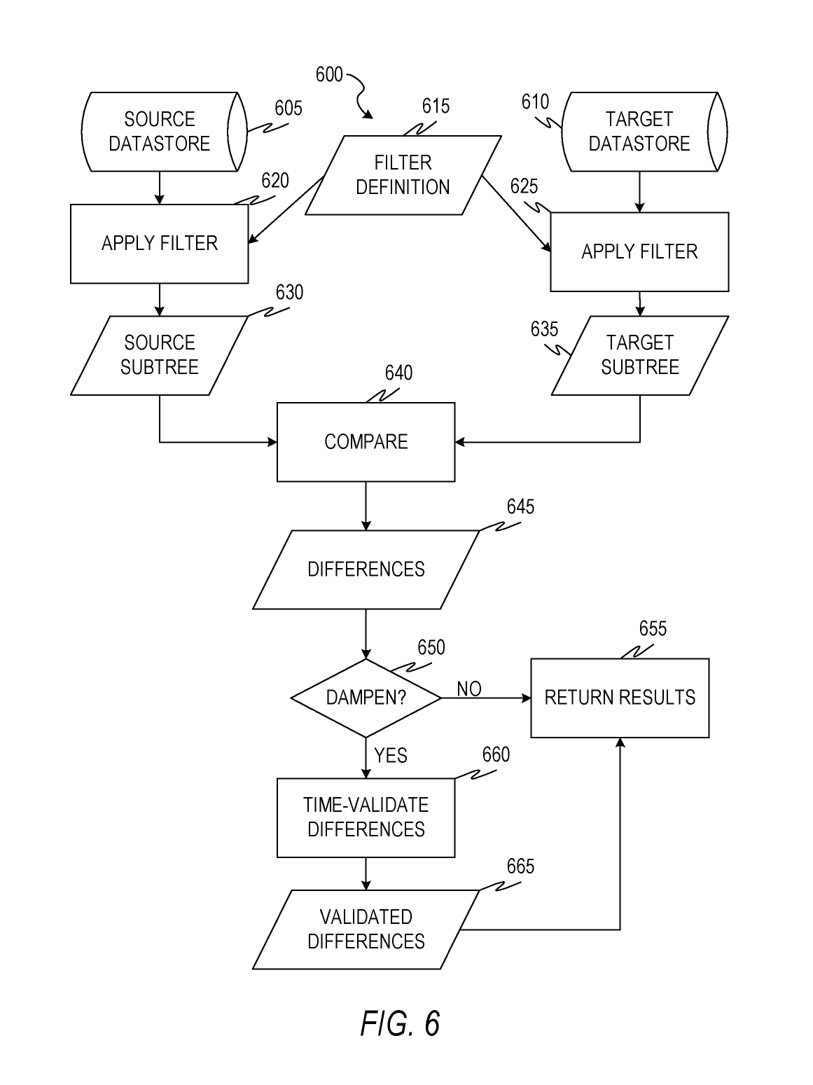

FIG. 6 is a flowchart illustration of a method 600 of discrepancy detection by a configuration server, according to some example embodiments. The method 600 includes operations 620, 625, 640, 650, 655, and 660. The operations take a source datastore 605, a target datastore 610, and a filter definition 615 as input, generate a source subtree 630 and a target subtree 635 as intermediate data, and generate differences 645 or validated differences 665 as output results to be returned. The method 600 may be invoked by the configuration server 120 in response to a compare request from the client 110, wherein the compare request identifies the source datastore 605, the target datastore 610, and the filter definition 615.

In operation 620, the NMDA module 260 of the configuration server 120 applies the filter definition 615 to the source datastore 605 to generate the source subtree 630. In some example embodiments, the source subtree 630 is a tree in which each node has a label and a value. The source subtree 630 may be represented using XML.

In operation 625, the NMDA module 260 applies the filter definition 615 to the target datastore 610 to generate the target subtree 635. The target subtree 635 may be of the same format as the source subtree 630. The filter may identify one or more subtrees of the two management datastores to be compared. For example, the XML fragment below may be used to select a top-level node of http://example com/schema/1.2/config, in the xmlns namespace, and its children for comparison. Other types of filters may also be used, such as attribute match, containment nodes, selection nodes, content match nodes, or any suitable combination thereof.

<filter type=“subtree”>

<top xmlns=“http://example.com/schema/1.2/config”/>

</filter>

In operation 640, the comparison module 265 compares the source subtree 630 with the target subtree 635 to identify the differences 645. The differences 645 may be a set of nodes, wherein each node has a label and two values. The label may be a fully qualified path to the node. In some example embodiments, the first value for each node is the value for that node in the source subtree 630, and the second value for each node is the value for that node in the target subtree 635. Null values may be used to indicate that the node is not present in the corresponding subtree.

In operation 650, the NMDA module 260 determines if dampened results are to be provided. For example, the compare request may indicate that dampened results are to be provided, along with a dampening time. As another example, an administrator may determine whether dampened results are to be provided and, if they are, define a dampening time to be applied.

In operation 655, if dampened results are not to be provided, the NMDA module 260 provides the differences 645 as the results. However, if dampened results are to be provided, the method 600 proceeds with operation 660.

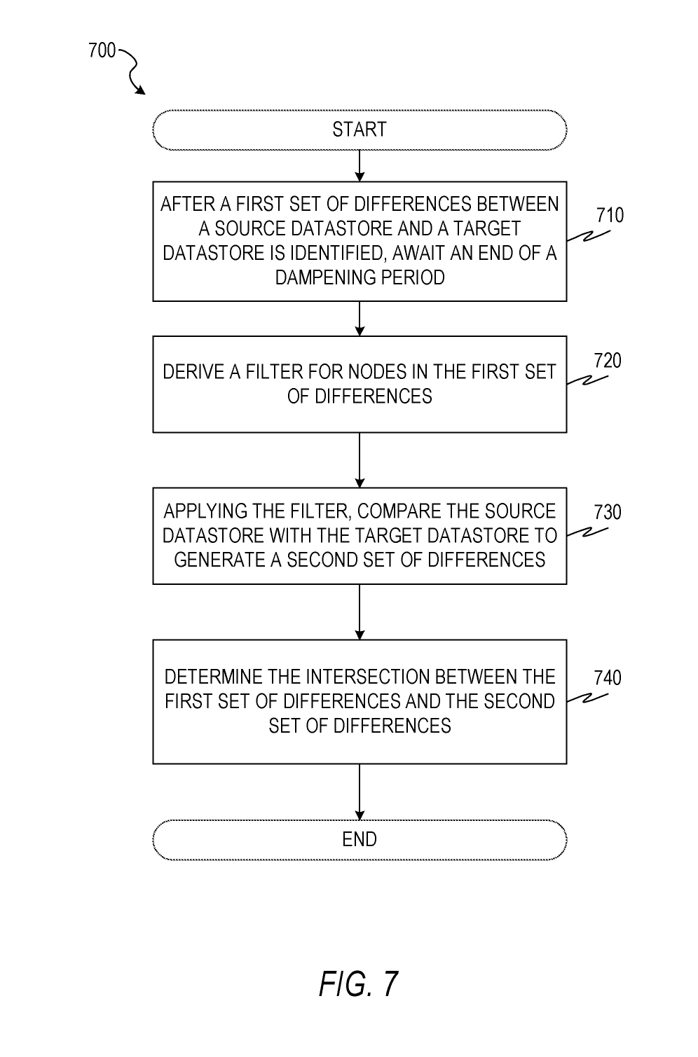

In operation 660, the NMDA module 260 time-validates the differences 645. This may be performed by allowing the dampening time to elapse and then repeating operations 620, 625, and 640 to generate a second set of differences, or by performing the method 700, described with respect to FIG. 7 below. Differences present in both the differences 645 and the second set of differences form the validated differences 665. The NMDA module 260, in operation 655, returns the validated differences 665 as the results.

FIG. 7 is a flowchart illustration of a method 700 of time-validating differences by a configuration server, according to some example embodiments. The method 700 may be performed as part of the method 600. The method 700 includes operations 710, 720, 730, and 740. By way of example and not limitation, the method 700 is described as being performed by elements of the configuration server 120, described above with respect to FIG. 1, and the computer 200, described above with respect to FIG. 2.

In operation 710, the NMDA module 260, after a first set of differences between a source datastore and a target datastore is identified, awaits an end of a dampening period.

In operation 720, the NMDA module 260 derives a filter for nodes in the first set of differences. For example, the filter may be defined such that a query using the filter that is run on either the source datastore or the target datastore will only return nodes that are present in the first set of differences.

In operation 730, the comparison module 265 applies the filter and compares the source datastore with the target datastore to generate a second set of differences. For example, a filtered query may be run against the source datastore to generate first data, and a filtered query may be run against the target datastore to generate second data. The comparison module 265 compares the first data with the second data to identify the second set of differences.

In operation 740, the comparison module 265 compares the first set of differences with the second set of differences to identify the intersection of the two sets. The intersection of two sets is the set that contains all elements of both sets, but no other elements. The intersection of the two sets of differences is the time-validated differences between the source datastore and the target datastore and contains the differences present both at the time the first set of differences was created and at the time the second set of differences was created (e.g., after the end of the dampening period).

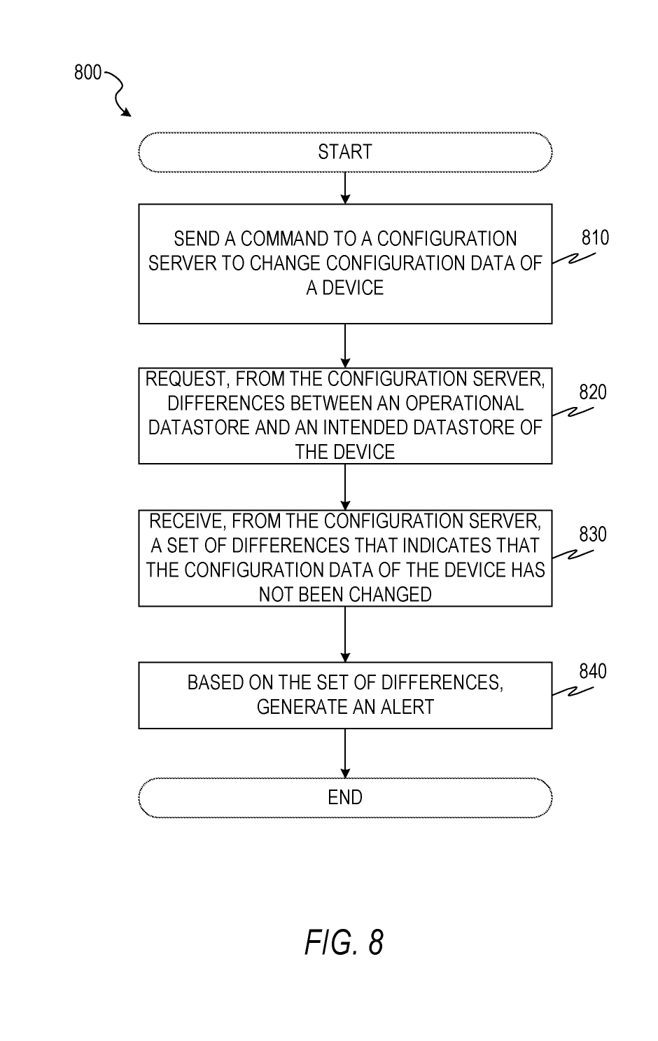

FIG. 8 is a flowchart illustration of a method 800 of generating an alert by a client, according to some example embodiments. The method 800 includes operations 810, 820, 830, and 840. By way of example and not limitation, the method 800 is described as being performed by the client 110 in communication with the configuration server 120, described above with respect to FIG. 1, and the computer 200, described above with respect to FIG. 2.

In operation 810, the client 110 sends a command to the configuration server 120 to change configuration data of a resource. For example, a user of the client 110 may use a graphical user interface of an application to switch off the smart light 170 and, in response, the application may send a management operation to the configuration server 120 that, when processed by the configuration server 120, results in changing data in the intended datastore 130 to indicate that the smart light 170 is intended to be off.

In operation 820, the client 120 sends a request to the configuration server 120 for differences between an operational datastore and an intended datastore of the resource. The configuration server 120 may handle this request using one or more of the methods 300, 400, 500, 600, and 700.

In operation 830, the client 110 receives, from the configuration server 120, a set of differences that indicates that the configuration data of the resource has not been changed. For example, if the smart light 170 were disconnected from the configuration server 120 and unable to receive the intended state change (or transmit an indication that the state change was successful), the operational datastore for the smart light 170 would not be changed. As a result, the set of differences would show that the intended state for the smart light 170 is off but the operational state is on.

In operation 840, based on the set of differences, the client 110 generates an alert. For example, a pop-up window may appear in the graphical user interface that indicates that the command to turn off the smart light 170 failed.

Devices and methods disclosed herein may reduce time, processor cycles, power consumed, and network usage in identifying differences between management datastores by a configuration server. For example, processing power required by NETCONF or RESTCONF clients to determine if intended configuration changes have propagated to an operational datastore may be reduced. Devices and methods disclosed herein may also result in an improved configuration monitoring system, resulting in improved efficiency and an improved user experience.

Although a few embodiments have been described in detail above, other modifications are possible. For example, the logic flows depicted in the figures do not require the particular order shown, or sequential order, to achieve desirable results. Other steps may be provided in, or steps may be eliminated from, the described flows, and other components may be added to, or removed from, the described systems. Other embodiments may be within the scope of the following claims.

What is claimed is:

1. A computer-implemented method of discrepancy detection in a configuration server, comprising:
receiving, by one or more processors of the configuration server from a configuration client, a request to compare a first management datastore with a second management datastore;
comparing, by the one or more processors of the configuration server, the first management datastore with the second management datastore to identify differences; and
in response to the request, sending over a network to the configuration client, by the one or more processors of the configuration server, the differences.

2. The computer-implemented method of claim 1, wherein the receiving of the request comprises receiving a Network Management Datastore Architecture (NMDA) command.

3. The computer-implemented method of claim 2, wherein the NMDA command is a NETCONF command.

4. The computer-implemented method of claim 2, wherein the NMDA command is a RESTCONF command.

5. The computer-implemented method of claim 2, wherein the receiving of the NMDA command comprises receiving an identifier of the first management datastore, an identifier of the second management datastore, and a filter.

6. The computer-implemented method of claim 5, wherein the receiving of the NMDA command further comprises receiving a dampening period.

7. The computer-implemented method of claim 5, wherein the comparing of the first management datastore with the second management datastore comprises:
selecting data from the first management datastore using the filter; and
selecting data from the second management datastore using the filter.

8. The computer-implemented method of claim 1, wherein the comparing of the first management datastore with the second management datastore comprises:
selecting data from the first management datastore using a first filter; and
selecting data from the second management datastore using a second filter that is different from the first filter.

9. The computer-implemented method of claim 8, wherein the second filter is based on the first filter and an origin.

10. A configuration server comprising:
a memory storage comprising instructions; and
one or more processors in communication with the memory storage, wherein the one or more processors execute the instructions to perform:
receiving a request to compare a first management datastore with a second management datastore;
comparing the first management datastore with the second management datastore to identify differences; and
in response to the request, sending the differences over a network.

11. The configuration server of claim 10, wherein the receiving of the request comprises receiving a Network Management Datastore Architecture (NMDA) command.

12. The configuration server of claim 11, wherein the NMDA command is a NETCONF command.

13. The configuration server of claim 11, wherein the NMDA command is a RESTCONF command.

14. The configuration server of claim 11, wherein the receiving of the NMDA command comprises receiving an identifier of the first management datastore, an identifier of the second management datastore, and a filter.

15. The configuration server of claim 14, wherein the receiving of the NMDA command further comprises receiving a dampening period.

16. The configuration server of claim 14, wherein the comparing of the first management datastore with the second management datastore comprises:
selecting data from the first management datastore using the filter; and
selecting data from the second management datastore using the filter.

17. The configuration server of claim 10, wherein the comparing of the first management datastore with the second management datastore comprises:
selecting data from the first management datastore using a first filter; and
selecting data from the second management datastore using a second filter that is different from the first filter.

18. The configuration server of claim 17, wherein the second filter is based on the first filter and an origin.

19. A non-transitory computer-readable medium storing computer instructions for detecting discrepancies by a configuration server, that when executed by one or more processors of the configuration server, cause the one or more processors to perform steps of:
receiving a request to compare a first management datastore with a second management datastore;
comparing the first management datastore with the second management datastore to identify differences; and
in response to the request, sending the differences over a network.

20. The non-transitory computer-readable medium of claim 19, wherein the receiving of the request comprises receiving a Network Management Datastore Architecture (NMDA) command.
